(19) United States
(12) Patent Application Publication
(10) Pub. No.: US 2025/0063971 A1
(43) Pub. Date: Feb. 27, 2025

(54) SYSTEMS AND METHODS FOR AN AGRICULTURAL IMPLEMENT

(71) Applicant: CNH Industrial America LLC, New Holland, PA (US)

(72) Inventors: Jesse Allen Stoller, Goodland, IN (US); Brad David Frank, LaCrosse, IN (US); William E. Preller, Congerville, IL (US); Brian Michael Craig, Congerville, IL (US); Austin Joseph Lewandowski, Congerville, IL (US); Caleb Roy Mohr, Normal, IL (US); Gabe DeBoeuf Tomlinson, Washington, IL (US); Sean Dale Jordal, Hudson, IL (US); Jeffry Scott Huber, Eureka, IL (US)

(21) Appl. No.: 18/810,792

(22) Filed: Aug. 21, 2024

Related U.S. Application Data
(60) Provisional application No. 63/578,760, filed on Aug. 25, 2023.

(51) Int. Cl. A01B 49/02; A01B 49/06; A01B 61/04; A01C 5/06; A01C 21/00

(52) U.S. Cl. CPC A01B 49/027; A01B 49/06; A01B 61/042; A01C 5/064; A01C 5/068; A01C 21/00; A01C 21/002

(57) ABSTRACT

In one aspect, an agricultural implement includes a row unit including a frame. A center coulter can be operably coupled with the frame. A knife can be operably coupled with the frame and positioned aft of the center coulter. A diverging gap can be defined between the center coulter and the knife such that the diverging gap increases in width in the forward/aft direction as a location along the knife moves upward.

### CROSS-REFERENCE TO RELATED APPLICATION

This application claims the benefit of priority under 35 U.S.C. § 119 (e) to U.S. Provisional Application No. 63/578,760, filed Aug. 25, 2023, and entitled “SYSTEMS AND METHODS FOR AN AGRICULTURAL IMPLEMENT”, which is hereby incorporated by reference in its entirety.

### FIELD OF THE INVENTION

The present subject matter relates generally to agricultural implements, such as strip tillage implements, and, more particularly, to a row unit suitable for use with the implement.

### BACKGROUND OF THE INVENTION

To increase agricultural performance from a field, a farmer may cultivate the soil, such as through a tillage operation. Tillage implements can include one or more ground-engaging tools configured to engage the soil as the implement is moved across the field. Such ground-engaging tool(s) loosen and/or otherwise agitate the soil to prepare the field for subsequent agricultural operations, such as planting operations. Strip tillage implements, unlike traditional tillage implements, include row units having one or more of such ground-engaging tools, where the row units can work narrow strips of the field in which subsequent operations (e.g., planting) will occur, instead of working the field along the swath of the implement.

Accordingly, a strip tillage implement with an improved knife and coulter row unit, and an associated system and method for use with such improved strip tillage implement, would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to an agricultural implement that includes a row unit including a frame. A center coulter is operably coupled with the frame. A knife is operably coupled with the frame and positioned aft of the center coulter. A diverging gap is defined between the center coulter and the knife increases in width in a forward/aft direction as a location along the knife moves upward.

In some aspects, the present subject matter is directed to a method of operating an agricultural implement. The method includes cutting through a portion of a field with a center coulter. The method also includes fracturing the portion of the field with a knife causing a trench. Lastly, the method includes forming a fracture zone with one or more side coulters, the fracture zone having a lateral width that is greater than the lateral width of the trench.

In some aspects, the present subject matter is directed to a row unit for an agricultural implement. The row unit includes a frame and a knife operably coupled with the frame. A first side coulter is operably coupled with the frame. The first side coulter is positioned aft of the knife and on a first side of a longitudinal axis of the row unit. A second side coulter is operably coupled with the frame. The second side coulter is positioned aft of the knife and on a second side of the longitudinal axis of the row unit.

These and other features, aspects, and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure directed to one of ordinary skill in the art is set forth in the specification, which makes reference to the appended figures, in which:

FIG. 1 illustrates a perspective view of an agricultural implement in accordance with aspects of the present subject matter;

FIG. 2 illustrates a side view of a row unit suitable for use with the implement shown in FIG. 1 in accordance with aspects of the present subject matter;

FIG. 3 illustrates a partial side view of the row unit of FIG. 2 in accordance with aspects of the present subject matter;

FIG. 4 illustrates a partial rear perspective view of the row unit of FIG. 2 in accordance with aspects of the present subject matter;

FIG. 5 illustrates a front view of the row unit of FIG. 2 in accordance with aspects of the present subject matter;

FIG. 6 illustrates a front perspective view of the row unit of FIG. 2 in accordance with aspects of the present subject matter; and

FIG. 7 is a flow diagram of a method of operating an agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural material within a fluid circuit. For example, “upstream” refers to the direction from which an agricultural material flows, and “downstream” refers to the direction to which the agricultural material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to an agricultural implement that includes one or more row units each including a respective frame. The implement may be configured as a strip tillage implement, a seed-planting implement, a fertilizer-dispensing implement, and/or any other suitable type of implement.

In some examples, a center coulter can be operably coupled with the frame. Additionally, a knife may be operably coupled with the frame and positioned aft of the center coulter. A diverging gap can be defined between the center coulter and the knife that increases in width in the forward/aft direction as a location along the knife moves upward.

Additionally or alternatively, a first side coulter can be operably coupled with the frame. The first side coulter can be positioned aft of the knife and on a first side of a longitudinal axis of the row unit. A second side coulter can be operably coupled with the frame. The second side coulter can be positioned aft of the knife and on a second side of a longitudinal axis of the row unit. In operation, the knife may fracture and lift the soil within the portion of the ground G causing a trench in the ground. In turn, the first and second side coulters interact with the portion of the ground after the knife form a fracture zone that is wider in a lateral direction that the trench. In some examples, the soil within the fracture zone may all be loosened leading to various field conditions, such as better seeding conditions, and plant development. Moreover, in some cases, an agricultural material may be placed within the trench, which may then be moved by the first and second side coulters to place fertilizer within the fracture zone.

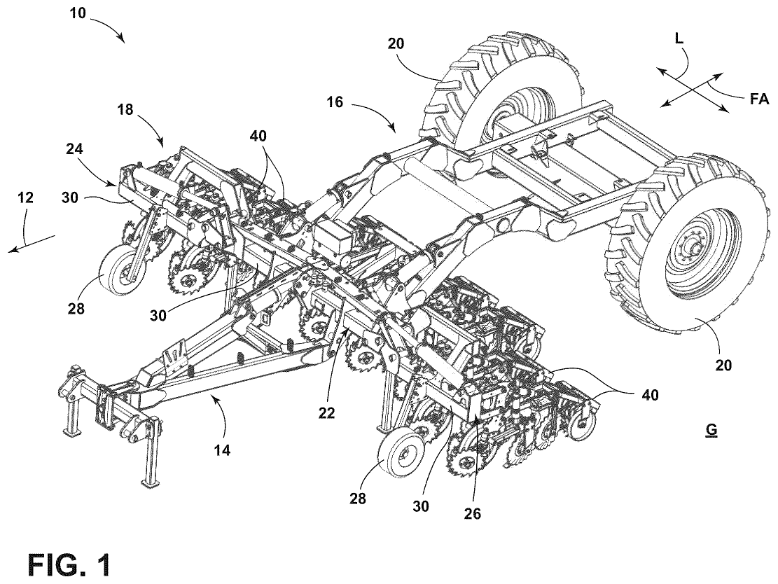

Referring now to the drawings, FIG. 1 illustrates a perspective view of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 can include a towbar assembly 14, a chassis assembly 16, and a toolbar assembly 18. The towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In some embodiments, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end portion of the chassis assembly 16 to support the implement 10 relative to the ground G.

It will be appreciated that, in the illustrated embodiment, the chassis assembly 16 is positioned at the aft end portion of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, the toolbar assembly 18 is pivotably coupled at its forward end portion to the towbar assembly 14 and at its aft end portion to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end portion of the implement 10. In such an embodiment, the forward end portion of the toolbar assembly 18 may be coupled to the aft end portion of the chassis assembly 16 (e.g., via connecting frame).

In several embodiments, the toolbar assembly 18 may be configured as a winged toolbar assembly. For instance, as shown in FIG. 1, the toolbar assembly 18 can include a central toolbar section 22 and one or more wing toolbar sections coupled to and extending laterally (e.g., in the lateral direction L) from central toolbar section 22 (e.g., a first wing toolbar section 24 coupled to one lateral end portion of the central toolbar section 22 and a second wing toolbar section 26 coupled to the opposed lateral end portion of the central toolbar section. 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground G. In some embodiments, the wing support wheels 28 may be configured to function as gauge wheels for the wing toolbar sections 24, 26.

In various examples, each of the various toolbar sections 22, 24, 26 may include one or more laterally extending toolbars 30 configured to support a plurality of row units 40. For instance, in some embodiments, each row unit 40 may be coupled to its respective toolbar 30 via a four-bar linkage. In the illustrated embodiment, the row units 40 is configured as strip tillage units. As such, each row unit 40 may include one or more ground-engaging tools for working the soil in narrow strips extending in the forward direction of travel 12 of implement 10. For instance, in some embodiments, each row unit 40 may include one or more row cleaner discs, coulters, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It will be appreciated that the configuration of the implement 10 described above and shown in FIG. 1 is provided only to place the present subject matter in an exemplary field of use. Thus, it will be appreciated that the present subject matter may be readily adaptable to any manner of implement configuration.

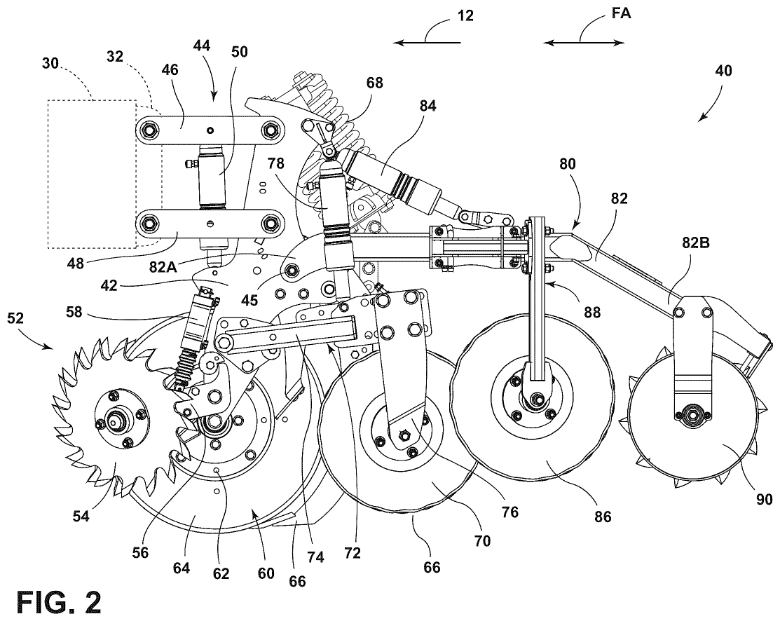

Referring now to FIG. 2, a side view of some embodiments of a row unit 40 suitable for use with the implement 10 shown in FIG. 1 is illustrated in accordance with aspects of the present subject matter. As shown, the row unit 40 can include a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in some embodiments, the frame 42 may be coupled to the toolbar 30 via a four-bar linkage including one or more pairs of first and second linkages 46, 48, with one end portion of each linkage 46, 48 being pivotably coupled to the frame 42 and the opposed end portion of each linkage 46, 48 being pivotably coupled to the toolbar 30 (e.g., via the associated mounting bracket(s) 32). However, it will be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In some embodiments, the downforce actuators 50 may be passive actuators, such as air shocks or springs. Alternatively, the downforce actuators 50 may be actively controlled actuators, such as pneumatic or hydraulic cylinders.

As shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end portion of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In some embodiments, the row cleaner 52 may include a pair of row cleaner discs 54 (one of which is shown in FIG. 2), with each disc 54 being pivotably coupled to the main frame via a respective row cleaner arm 56. In various examples, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 can include a pair of row cleaner actuators 58 (one of which is shown in FIG. 2) configured to provide a downward biasing force against the row cleaner 52, with each row cleaner actuator 58 being coupled between the main frame 42 and a respective row cleaner arm 56. In some embodiments, the row cleaner actuators 58 may be passive actuators, such as air shocks or springs. Alternatively, the row cleaner actuators 58 may be actively controlled actuators, such as pneumatic or hydraulic cylinders.

With further reference to FIG. 2, the row unit 40 may also include a center coulter 60 positioned aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In some embodiments, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in some embodiments, as the row cleaner discs 54 rotate relative to the ground G (FIG. 1), the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a knife 66 mounted to the main frame 42 at a location aft of the central hub 62 relative to the forward direction of travel 12 of the implement 10. In some embodiments, the knife 66 may generally be aligned with the center coulter 60 along the longitudinal centerline of the row unit 40 (i.e., aligned with the center coulter 60 in the longitudinal direction of the implement 10). The knife 66 may be configured to break out the soil along the lateral width of the row being formed by the row unit 40 at a location aft of the center coulter 60. For example, the knife 66 may be aligned with the blade 64 of the center coulter 60 such that the knife 66 travels through and breaks open the slit or slot cut into the soil via the center coulter 60. In alternative embodiments, the knife 66 may be replaced with a different ground-engaging tool, such as a centralized shank positioned immediately aft of the center coulter 60.

As shown in FIG. 2, the row unit 40 may also include one or more shank actuators 68 provided in association with the knife 66 for providing a downward biasing force thereto. For instance, in the illustrated embodiment, the row unit 40 can include a pair of shank actuators 68, with each shank actuator 68 being operably coupled between the main frame 42 and the knife 66. In some embodiments, the shank actuators 68 may be passive actuators, such as air shocks or springs. Alternatively, the shank actuators 68 may be actively controlled actuators, such as pneumatic or hydraulic cylinders.

Additionally, in several embodiments, the row unit 40 may include a forward or first pair of side coulters 70 (one of which is shown in FIG. 2) positioned aft of the center coulter 60 relative to the forward direction of travel 12, with each first side coulter 70 being disposed along either side of the knife 66 such that the side coulters 70 are spaced apart from the knife 66 in the lateral direction L of the implement 10. In some embodiments, each first side coulter 70 is pivotably coupled to the main frame 42 via a first side coulter mount assembly 72. For instance, as shown in FIG. 2, the side coulter arm assembly 72 can include a mounting arm 74 and a support arm 76, with the mounting arm 74 being pivotably coupled to the main frame 42 at one end portion and being coupled to the support arm 76 at the other end portion. The support arm 76 may, in turn, be coupled between the mounting arm 74 and its respective first side coulter 70 in a manner that allows the coulter 70 to rotate relative to the support arm 76 as the row unit 40 is being moved across the field. As shown in FIG. 2, the row unit 40 may also include one or more side coulter actuators 78 provided in association with the side coulters 70 for applying a downward biasing force thereto. For instance, in the illustrated embodiment, the row unit 40 can include a pair of side coulter actuators 78 (one of which is shown in FIG. 2), with each side coulter actuator 78 being coupled between the main frame 42 and a respective coulter arm assembly 72. In some embodiments, the side coulter actuators 78 may be passive actuators, such as air shocks or springs. Alternatively, the side coulter actuators 78 may be actively controlled actuators, such as pneumatic or hydraulic cylinders.

In several embodiments, the side coulters 70 may function together with the central knife 66 to break out the soil along the width of the strip being worked or formed by the row unit 40. For instance, the side coulters 70 may be configured to “score” the soil to provide a pre-fracture at the desired width of the strip being formed. As an example, the side coulters 70 may be configured to run at a relatively shallow depth (e.g., 1-2 inches) to create scores or fracture lines” within the soil along the lateral edges of the row being formed. The knife 66 may, in turn, be configured to break out the hard soil across the lateral width extending between the fracture lines created by the side coulters 70.

Referring still to FIG. 2, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (one of which is shown in FIG. 2) extending between a forward end portion 82A and an aft end portion 82B, with the forward end portion 82A of each frame member 82 being pivotably coupled to the main frame 42 at a forward pivot point 45. Each frame member 82 extends rearwardly from the pivot point 45 relative to the forward direction of travel 12 to its aft end portion 82B positioned adjacent to the aft end portion of the row unit 40. Additionally, in some embodiments, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 can include a pair of aft frame actuators 84 (only one of which is shown in FIG. 2), with each aft frame actuator 84 being coupled between the main frame 42 and a respective aft frame member 82 of the aft frame assembly 80. In some embodiments, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulters 86 positioned aft or rearward of the forward or first pair of side coulters 70 (and aft of the knife 66) relative to the forward direction of travel 12, with each aft side coulter 86 being disposed along either side of the longitudinal centerline of the row unit 40 such that the aft side coulters 86 are spaced apart from the centerline in the lateral direction L of the implement 10. In some embodiments, the aft side coulter 86 may be configured to catch or block the soil coming off of the first side coulters 70 and knife 66 and redirect such soil back towards the center of the row being formed. As a result of redirecting the thrown soil back towards the center of the row, the aft or second side coulters 86 may function as “berm builders” to create a berm of soil along the centerline of the row unit 40. In such instances, the aft side coulter 86 may be set to run at a relatively shallow depth (e.g., 1 inch or less) so that the coulters 86 can catch the soil without effectively tilling the soil. Alternatively, the second side coulters 86 may be set at a less shallow depth to allow the coulters 86 to perform shallow tillage (e.g., to widen the strip of worked soil beyond what the first side coulters 70 achieved) while still performing the function of directing soil into the right lateral shape to build a proper berm across the width of the row. In some embodiments, each aft side coulter 86 is coupled to the aft frame assembly 80 via a second side coulter mount assembly 88. In some embodiments, the side coulter mount assembly 88 may be configured to allow the positioning of the second side coulters 86 to be adjusted relative to the other tools of the row unit 40, thereby allowing the coulters 86 to be set properly for performing their soil-catching function.

With further reference to FIG. 2, the row unit 40 may also include a finishing tool positioned at the aft end portion of the row unit 40. For example, in the illustrated embodiment, the row unit 40 can include a strip conditioner 90 coupled to the aft end portion 82B of the aft frame assembly 80. In general, the strip conditioner 90 may have any suitable configuration that allows it to perform its function as a finishing tool. In some embodiments, the strip conditioner 90 may be configured as a spider conditioner that functions to reduce the size of soil clods across the width of the row being formed. In other embodiments, a conditioning reel or basket may be used as the finishing tool.

It will be appreciated that the configuration of the row unit 40 described above and shown in FIG. 2 is provided only to place the present subject matter in an exemplary field of use. Thus, it will be appreciated that the present subject matter may be readily adaptable to any manner of row unit configuration.

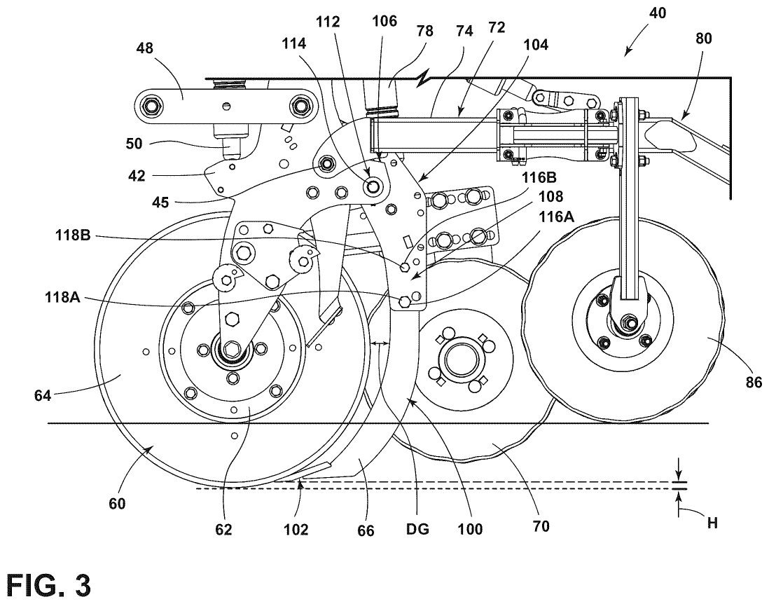

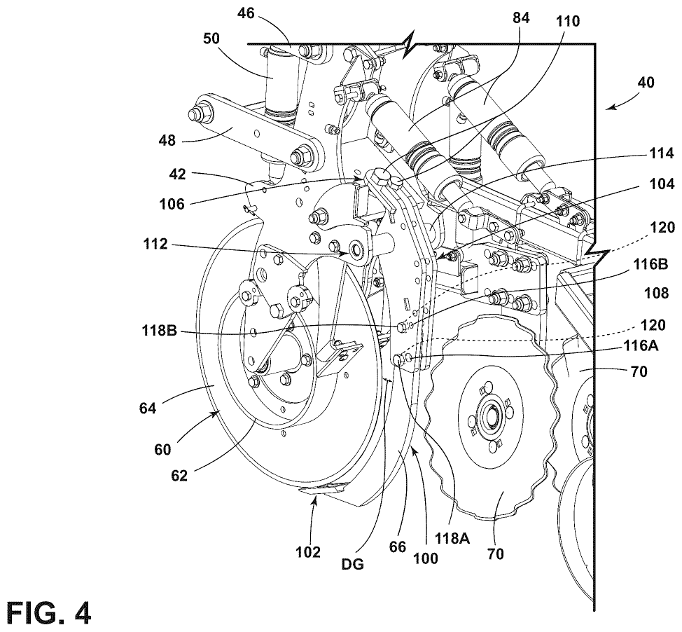

Referring now to FIGS. 3 and 4, the knife 66 can include a first section 100 operably coupled with the frame 42 and a second section 102 operably coupled (and/or integrally formed with) the first section 100. In some embodiments, the second section 102 of the knife 66 may extend to a position that is above the peripheral blade 64 extending radially outwardly from the hub 62 of the center coulter 60 by a set height H. As such, the coulter may pre-fracture the ground G prior to the ground G interacting with the knife 66, which in turn, may reduce the draft load of the row unit 40. In some instances, the knife 66 may be configured to have a general operating depth of five to eight inches (and/or any other practicable depth).

As shown in FIGS. 3 and 4, the knife 66 may be operably coupled to the frame 42 through a knife bracket 104. In various examples, the knife bracket 104 can include an upper first segment 106 that is operably coupled with the frame 42 and a lower second segment 108 that is operably coupled with the knife 66. One or more fasteners 110 may be positioned through holes defined by the first segment 106 of the knife bracket 104 and into corresponding holes defined by the frame 42 to retain the knife bracket 104 in a defined location relative to the frame 42. Additionally or alternatively, the second segment 108 of the knife bracket 104 and the frame 42 can define respective holes 112 therethrough and a rod 114 may be placed through the holes 112 to retain the knife bracket 104 in the defined location relative to the frame 42. Further, the second segment 108 of the knife bracket 104 may define one or more retainment openings 116A, 116B that allow for the knife 66 to be removably coupled with the bracket when one or more retainers 118A, 118B are positioned through the one or more retainment openings 116A, 116B. Further, the knife 66 defines one or more receiving holes that correspond to the one or more retainment openings 116A, 116B defined by the knife bracket 104.

In some embodiments, such as the one shown in FIGS. 3 and 4, the first section 100 of the knife 66 may have a curved geometry. Moreover, the first section 100 of the knife 66 may be separated from the peripheral blade 64 by a diverging gap DG in the vertical direction. In other words, a distance between the peripheral blade 64 and a location on the first section 100 of the knife 66 increases as the distance between the location on the first section 100 of the knife 66 and the frame 42 of the row unit 40 decreases. In operation, as the second section 102 of the knife 66 and/or the center coulter 60 wear, some residue may be disposed between the center coulter 60 and the knife 66. Due to the diverging gap DG between the center coulter 60 and the knife 66, the residue may continue to move upward and be released from the diverging gap DG reducing plugging conditions.

In some embodiments, the one or more retainment openings 116A, 116B can include a lower retainment opening 116A and an upper retainment opening 116B relative to a vertical direction, as indicated by line V in FIG. 3. In some cases, a diameter of the lower retainment opening 116A may vary from a diameter of the upper retainment opening 116B. In such instances, a retainer 118A in the form of a pivot bolt may be positioned through the lower retainment opening 116A and a retainer 118B in the form of a shear bolt may be positioned through the upper retainment opening 116B. Thus, in situations in which an excessive force is placed on the knife 66, the shear bolt may break thereby allowing the knife 66 to rotate relative to the knife bracket 104 to reduce damage to the knife 66 and/or the knife bracket 104.

Further, in various examples, the knife bracket 104 may include a first pair of retainment openings 116A, 116B and a second pair of retainment openings 116A, 116B that allow for depth adjustment of the knife depth. For instance, as illustrated in FIGS. 3 and 4, a lower hole of the first pair of retainment openings 116A, 116B may be positioned below and forward of a lower hole of the second pair of retainment openings 116A, 116B. Similarly, an upper hole of the first pair of retainment openings 116A, 116B may be positioned below and forward of an upper hole of the second pair of retainment openings 116A, 116B. As such, the knife 66 can follow the curvature of the center coulter 60 so that the diverging gap DG can be maintained with the knife 66 at various depths.

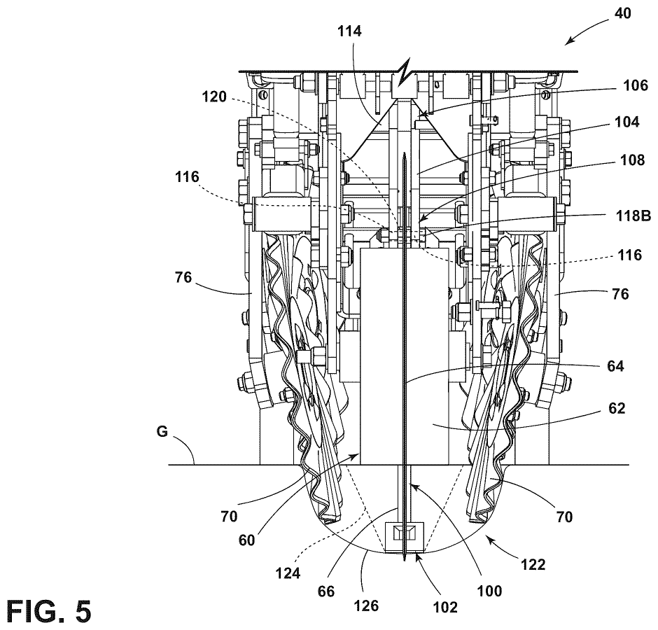

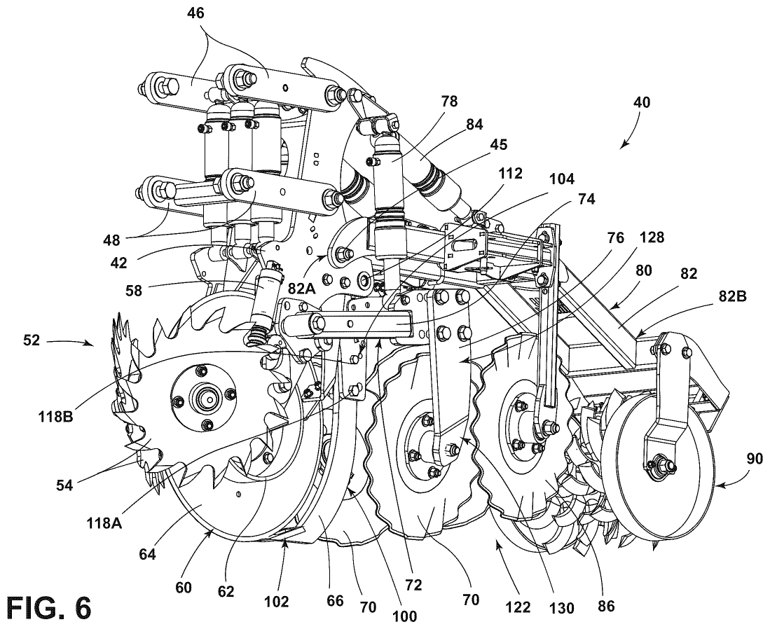

Referring now to FIGS. 5 and 6, a knife coulter assembly 122 is illustrated in accordance with various aspects of the present disclosure. As provided herein, the knife coulter assembly 122 may include the knife 66 and one or more side coulters 70 that are positioned aft of the knife 66 and/or laterally outward of the knife 66.

In various embodiments, the center coulter 60 may cut through a portion of the ground G prior to working of the ground G by the knife coulter assembly 122. In turn, the knife 66 may fracture and lift the soil within the portion of the ground G causing a trench, which is illustrated in FIG. 5 by line 124 and may be generally V-shaped, in the ground. It will be appreciated that the width of the trench may be varied based on the geometry of the knife 66, the vertical resistance caused by the knife 66, the soil conditions, and so on. In turn, the side coulters 70, which are positioned aft of the knife 66 and interact with the portion of the ground after the knife 66 by interacting with the soil proximate to the trench to cause the side coulters 70 to form a fracture zone, which is illustrated in FIG. 5 by line 126 and may be a “flowerpot” shape, that is wider in the lateral direction that the trench. In some examples, the soil within the fracture zone may all be loosened leading to various field conditions, such as better seeding conditions, and plant development. Moreover, in some cases, an agricultural material may be placed within the trench, which may then be moved by the side coulters 70 to place fertilizer within the fracture zone. As an example, the knife coulter assembly 122 provided herein may be configured to form a fracture zone that is five (5)—eight (8) inches deep and five (5)—fifteen (15) inches wide.

With further reference to FIG. 6, the side coulter arm assembly 72 can include a mounting arm 74 and a support arm 76, with the mounting arm 74 being pivotably coupled to the main frame 42 at one end portion and being coupled to the support arm 76 at the other end portion. The support arm 76 may, in turn, be coupled between the mounting arm 74 and its respective first side coulter 70 in a manner that allows the coulter 70 to rotate relative to the support arm 76 as the row unit 40 is being moved across the field. As illustrated, in some embodiments, the support arm can include an upper first portion 128 and a lower second portion 130 that together form a compound angle such that the first side coulter 70 and/or the second side coulter 70 are non-parallel to a longitudinal axis (and/or a lateral axis) of the row unit 40. For example, the support arm may be configured to rotate the side coulter 70 in a toed-in and cambered orientation. As such, the first side coulter 70 and the second side coulter 70 may each be toed-in relative to the longitudinal axis of the row unit 40 and/or cambered relative to a lateral axis of the row unit 40. In such examples, the side coulters 70 may be configured to push direct towards a longitudinal centerline of the row unit 40 and upwardly relative to the vertical direction.

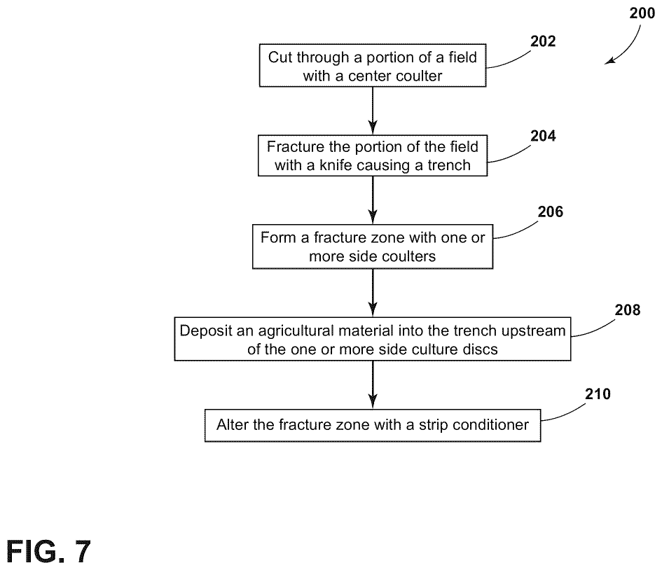

Referring now to FIG. 7, a flow diagram of a method 200 of operating an agricultural implement is illustrated in accordance with aspects of the present subject matter. In general, the method 200 will be described herein with reference to the agricultural implement 10 shown in FIGS. 1-6. However, it will be appreciated that the disclosed method 200 may be implemented with agricultural machines having any other suitable machine configurations and/or within systems having any other suitable system configuration without deviating from the present disclosure. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include cutting through a portion of a field with a center coulter. As provided herein, one or more row cleaner assemblies can be positioned at the forward end portion of one or more row units of the agricultural implement. The center coulter can be positioned aft of the row cleaner assembly relative to the forward direction of travel of the implement. The center coulter may generally be configured to cut a slot or slit within the field along the center of the “row” being processed or formed by the row unit. Additionally, the center coulter may also function together with the row cleaner assembly to ensure that residue and other trash is swept or moved laterally away from the travel path of further downstream components of the row unit.

At (204), the method 200 can include fracturing and lifting the portion of the field with a knife causing a trench. In some examples, the trench may be generally V-shaped. However, it will be appreciated that the width and geometry of the trench may be varied based on the geometry of the knife, the vertical resistance caused by the knife, the soil conditions, and so on.

At (206), the method includes forming a fracture zone with one or more side coulters. In some cases, the fracture zone can define a lateral width that is greater than a lateral width of the trench. Additionally or alternatively, the fracture zone can have a geometric shape that is varied from a geometric shape of the trench.

At (208), the method 200 can include depositing an agricultural material into the trench upstream of the one or more side coulters. As provided herein, each row unit may also incorporate one or more components for supplying agricultural materials to the soil, such as injectors or tubes for directing agricultural material (e.g., fertilizer) supplied from a storage tank (or from any other source) into the worked soil.

At (210), the method 200 can include altering the fracture zone with a strip conditioner. As provided herein, in some embodiments, the strip conditioner may be configured as a spider conditioner that functions to reduce the size of soil clods across the width of the row being formed. Additionally or alternatively, a conditioning reel or basket may be used as the finishing tool.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural implement, comprising:
a row unit including a frame;
a center coulter operably coupled with the frame; and
a knife operably coupled with the frame and positioned aft of the center coulter, wherein a diverging gap is defined between the center coulter and the knife increases in width in a forward/aft direction as a location along the knife moves upward.

2. The agricultural implement of claim 1, wherein the center coulter includes a peripheral blade extending radially outwardly from a hub.

3. The agricultural implement of claim 2, wherein the peripheral blade extends vertically below the knife.

4. The agricultural implement of claim 1, further comprising:
a knife bracket operably coupled with the frame and the knife, the knife bracket defining one or more retainment openings.

5. The agricultural implement of claim 4, wherein the knife defines one or more receiving holes that correspond to the one or more retainment openings defined by the knife bracket.

6. The agricultural implement of claim 5, wherein the one or more retainment openings include a lower retainment opening and an upper retainment opening relative to a vertical direction.

7. The agricultural implement of claim 6, wherein a diameter of the lower retainment opening is varied from a diameter of the upper retainment opening.

8. The agricultural implement of claim 7, wherein a pivot bolt is positioned through the lower retainment opening and a shear bolt is positioned through the upper retainment opening.

9. The agricultural implement of claim 1, further comprising:
a first side coulter operably coupled with the frame, the first side coulter positioned aft of the knife and on a first side of a longitudinal axis of the row unit; and
a second side coulter operably coupled with the frame, the second side coulter positioned aft of the knife and on a second side of the longitudinal axis of the row unit.

10. The agricultural implement of claim 9, wherein the first side coulter and the second side coulter are each toed-in relative to the longitudinal axis of the row unit.

11. The agricultural implement of claim 9, wherein the first side coulter and the second side coulter are each cambered relative to a lateral axis of the row unit.

12. A method of operating an agricultural implement, the method comprising:
cutting through a portion of a field with a center coulter;
fracturing the portion of the field with a knife causing a trench; and
forming a fracture zone with one or more side coulters, the fracture zone having a lateral width that is greater than the lateral width of the trench.

13. The method of claim 12, wherein the fracture zone has a geometric shape that is varied from a geometric shape of the trench.

14. The method of claim 12, further comprising:
depositing an agricultural material into the trench upstream of the one or more side coulters.

15. The method of claim 12, further comprising:
altering the fracture zone with a strip conditioner.

16. A row unit for an agricultural implement, the row unit comprising:
a frame;
a knife operably coupled with the frame;
a first side coulter operably coupled with the frame, the first side coulter positioned aft of the knife and on a first side of a longitudinal axis of the row unit; and
a second side coulter operably coupled with the frame, the second side coulter positioned aft of the knife and on a second side of the longitudinal axis of the row unit.

17. The row unit of claim 16, further comprising:
a center coulter operably coupled with the frame and positioned forward of the knife.

18. The row unit of claim 17, wherein a diverging gap is defined between the center coulter and the knife, the diverging gap increasing in width in a forward/aft direction as a location along the knife moves upward.

19. The row unit of claim 16, wherein the knife forms a trench in a portion of a ground, and wherein the first side coulter and the second side coulter, in combination, form a fracture zone, the fracture zone having a lateral width that is greater than the trench.

20. The row unit of claim 16, wherein the first side coulter and the second side coulter are non-parallel to the longitudinal axis of the row unit.
